(19) United States
(12) Patent Application Publication
(10) Pub. No.: US 2015/0160516 A1
(43) Pub. Date: Jun. 11, 2015

(54) LIQUID CRYSTAL DISPLAY DEVICE

(71) Applicant: Japan Display Inc., Tokyo (JP)

(72) Inventors: Emi HIGANO, Tokyo (JP); Toshiyuki HIGANO, Tokyo (JP); Takenori HIROTA, Tokyo (JP)

(73) Assignee: Japan Display Inc.

(21) Appl. No.: 14/564,131

(22) Filed: Dec. 9, 2014

(30) Foreign Application Priority Data
Dec. 9, 2013 (JP) 2013-254208

(51) Int. Cl. G02F 1/1337; G02F 1/1343; G02F 1/1368

(52) U.S. Cl. CPC G02F 1/133723; G02F 1/1368; G02F 1/133788; G02F 1/133784; G02F 1/134363

(57) ABSTRACT

A liquid crystal display device includes a TFT substrate, a counter substrate, a liquid crystal layer, a first alignment film arranged between the TFT substrate and the liquid crystal layer, and a second alignment film arranged between the counter substrate and the liquid crystal layer. The first alignment film has a two-layer structure including a photo-alignment component and a low resistance component whose resistance is lower than that of the photo-alignment component, and the transmittance of the second alignment film is greater than that of the first alignment film.

### CLAIM OF PRIORITY

The present application claims priority from Japanese patent application JP2013-254208 filed on Dec. 9, 2013, the content of which is hereby incorporated by reference into this application.

### BACKGROUND

The present disclosure relates to a liquid crystal display device. For example, the present disclosure can be applied to a liquid crystal display device including an alignment film.

Display of a liquid crystal display device is performed by changing optical characteristics of a liquid crystal layer sandwiched by a pair of substrates by applying an electric field to liquid crystal molecules in the liquid crystal layer and changing an alignment direction of the liquid crystal molecules. In the liquid crystal display device, an alignment control film that is given a liquid crystal alignment control capability is formed in interfaces between the liquid crystal layer and the pair of substrates that sandwich the liquid crystal layer. The alignment control film is formed of an organic film such as polyimide and is also called an alignment film.

To improve DC afterimage characteristics, for example, in Japanese Laid-open Patent Publication No. 2011-170031 (Patent Document 1), the alignment film has two layers including a lower layer of low resistance component (polyamide acid) and an upper layer of alignment component (polyamide acid ester) . Further, to improve light transmittance, for example, in Japanese Laid-open Patent Publication No. 2011-107492 (Patent Document 2), a thickness of a second photo-alignment film formed on a second substrate including a color filter and the like is set to smaller than a thickness of a first photo-alignment film formed on a first substrate including an active element and the like.

### SUMMARY

In Patent Document 1, the lower layer of the alignment film includes the low resistance component, so that the light transmittance is lowered.

Other problems and new features will be obvious from the description of the present disclosure and the attached drawings.

The following explains briefly an outline of a typical device in the present disclosure.

A liquid crystal display device includes a first alignment film between a TFT substrate and a liquid crystal layer and a second alignment film between a counter substrate and the liquid crystal layer. The second alignment film is different from the first alignment film and is an alignment film without limitation in electrical characteristics.

According to the liquid crystal display device described above, it is possible to improve the transmittance.

### BRIEF DESCRIPTION OF THE DRAWINGS

FIG. 1 is a cross-sectional view showing a structure of a display area of a liquid crystal display device according to an implementation example.

FIG. 2 is a plan view showing a pixel electrode.

FIG. 3 is a cross-sectional schematic view showing a structure of a liquid crystal display device according to a comparative example.

FIG. 4 is a cross-sectional schematic view showing a structure of a liquid crystal display device according to an embodiment.

### DESCRIPTION OF THE PREFERRED EMBODIMENTS

Hereinafter, an embodiment, an implementation example, and a comparative example will be described with reference to the drawings. In the description below, the same components are denoted by the same reference numerals, and repetitive description will be omitted.

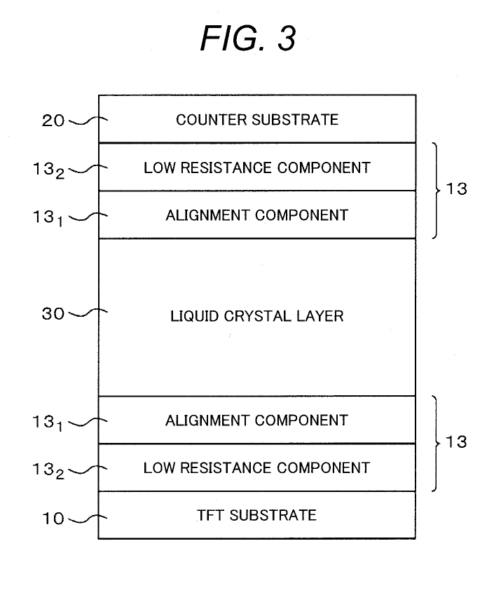

FIG. 3 is a cross-sectional schematic view showing a structure of a liquid crystal display device according to a comparative example. The liquid crystal display device according to the comparative example includes alignment films 13 between a TFT substrate 10 and a liquid crystal layer 30 and between a counter substrate 20 and the liquid crystal layer 30. The alignment film 13 has a two-layer structure including an alignment component 13₁ and a low resistance component 13₂. The alignment film 13 includes the low resistance component, so that light transmittance is lowered. In the present specification, it is described that the alignment film has a two-layer structure. However, there is a case in which the two layers are not completely separated from each other. Specifically, there is a case in which the alignment film 13 includes the alignment component 13₁ and the low resistance component 13₂, however these components are not clearly separated into layers by a boundary and a component ratio of each component varies in the thickness direction. For example, there is a case in which most of a surface layer closest to the liquid crystal layer is the alignment film component, however the alignment component 13₁ and the low resistance component 13₂ coexist along the thickness direction. In the present specification, the structure of this case is also represented as the two-layer structure.

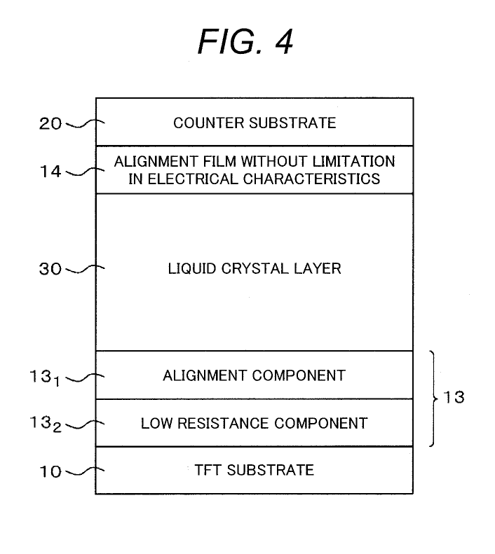

FIG. 4 is a cross-sectional schematic view showing a structure of a liquid crystal display device according to the embodiment. The liquid crystal display device according to the embodiment includes an alignment film 13 between a TFT substrate 10 and a liquid crystal layer 30 and an alignment film 14 between a counter substrate 20 and the liquid crystal layer 30. The alignment film 14 is different from the alignment film 13 and is an alignment film without limitation in electrical characteristics.

In a transverse electric field type liquid crystal device, a low resistance component is required on the TFT substrate side, so that an alignment film having a low resistance component is used on the TFT substrate side, and an alignment film without limitation in electrical characteristics is used on the counter substrate side. Thereby, it is possible to improve the transmittance.

In the implementation example described below, a transverse electric field type liquid crystal display device, that is, an IPS (In Plane Switching) type liquid crystal display device, will be described as an example. However the liquid crystal display device is not limited to these, but the implementation example can also be applied to a transverse electric field liquid crystal display device of all IPS types such as an FFS (Fringe Field Switching) type.

### Implementation Example

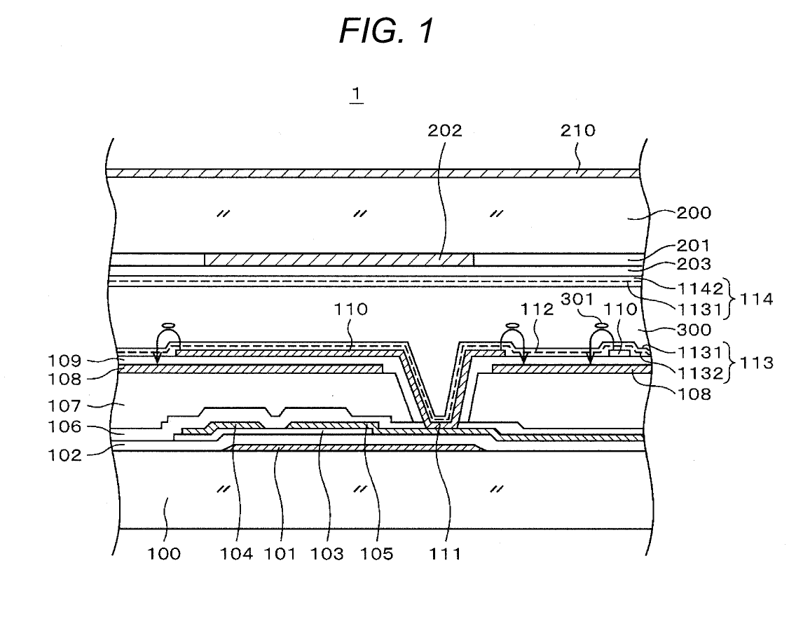

FIG. 1 is a cross-sectional view showing a structure of a display area of the liquid crystal display device according to the implementation example. The liquid crystal display device is an IPS type liquid crystal display device and has a structure in which a comb-teeth-shaped pixel electrode 110 is formed on a counter electrode 108 formed in a matted manner in plane with an insulating film in between. An image is formed by controlling light transmittance of a liquid crystal layer 300 for each pixel by rotating liquid crystal molecules 301 by a voltage between the pixel electrode 110 and the counter electrode (also referred to as a common electrode) 108. Hereinafter, the structure of FIG. 1 will be described in detail. In the present implementation example, the structure of FIG. 1 will be described as an example. However, the present implementation example can be applied to liquid crystal display devices other than the one shown in FIG. 1.

In FIG. 1, a gate electrode 101 is formed on a TFT substrate 100 formed of glass. The gate electrode 101 is formed of the same metal layer as that of a scanning line. The gate electrode 101 is covered with an insulating film 102 formed of SiN. On the insulating film 102, a semiconductor layer 103 is formed at a position facing the gate electrode 101. The semiconductor layer 103 forms a channel portion of the TFT. A source electrode 104 and a drain electrode 105 are formed on the semiconductor layer 103 with the channel portion in between. The source electrode 104 is also used as a video signal line and the drain electrode 105 is connected to the pixel electrode 110. The source electrode 104 and the drain electrode 105 are formed of the same metal layer at the same time.

The TFT is covered with an inorganic passivation film 106 formed of SiN. The inorganic passivation film 106 protects, in particular, the channel portion of the TFT from impurities. An organic passivation film 107 such as a polyimide resin is formed on the inorganic passivation film 106. The organic passivation film 107 has a function to protect the TFT and flatten the surface of the TFT, so that the organic passivation film 107 is formed to be thick. The counter electrode 108 is formed on the organic passivation film 107. The counter electrode 108 is covered with an insulating film 109 formed of SiN. The pixel electrode 110 is formed so as to cover the insulating film 109 and a through-hole 111. In the through-hole 111, the drain electrode 105 extended from the TFT and the pixel electrode 110 are electrically connected to each other, and the video signal is supplied to the pixel electrode 110. The counter electrode 108 and the pixel electrode 110 are formed of ITO that is a transparent conductive film. Although the inorganic passivation film and the organic passivation film are provided, only the inorganic passivation film or only the organic passivation film may be provided. Although a structure of a bottom gate in which the semiconductor layer is provided on the gate electrode formed on the TFT substrate is disclosed, a structure of a top gate in which the semiconductor layer is provided on the TFT substrate and the gate electrode is provided on the semiconductor layer may be employed.

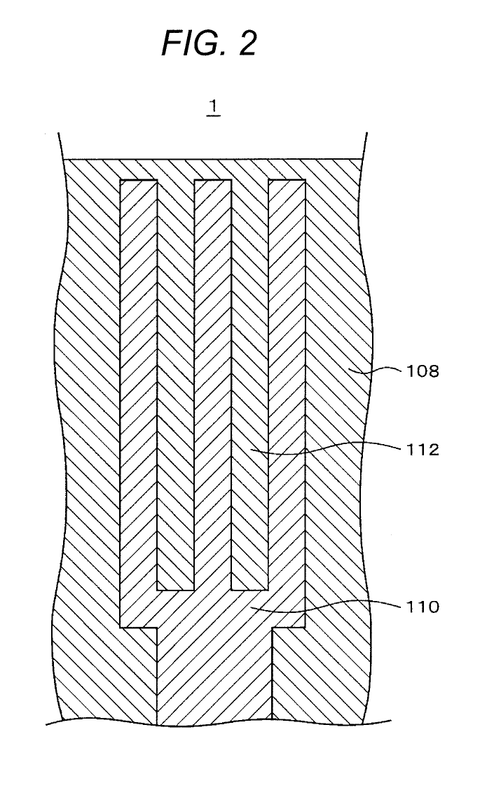

FIG. 2 shows an example of the pixel electrode 110. The pixel electrode 110 is a comb-teeth-shaped electrode. A slit 112 is formed between comb teeth. A planar counter electrode 108 is formed below the pixel electrode 110. When the video signal is applied to the pixel electrode 110, the liquid crystal molecules 301 are rotated by an electric field generated between the pixel electrode 110 and the counter electrode 108 though the slit 112. Thereby, the light passing through the liquid crystal layer 300 is controlled and an image is formed.

FIG. 1 illustrates the situation described above as a cross-sectional view. A gap between comb-teeth-shaped electrodes is the slit 112 shown in FIG. 1. A constant voltage is applied to the counter electrode 108 and a voltage of the video signal is applied to the pixel electrode 110. When a voltage is applied to the pixel electrode 110, as shown in FIG. 1, an electric line of force is generated, the liquid crystal molecules 301 are rotated in a direction of the electric line of force, and transmission of light from a backlight is controlled. The transmission of light from the backlight is controlled for each pixel, so that an image is formed.

In the example of FIG. 1, the counter electrode 108 formed into a sheet shape is arranged on the organic passivation film 107 and the comb-teeth-shaped electrode 110 is arranged on the insulating film 109. However, on the contrary, a pixel electrode 110 formed into a sheet shape may be arranged on the organic passivation film 107 and a comb-teeth-shaped counter electrode 108 may be arranged on the insulating film 109.

An alignment film 113 for aligning the liquid crystal molecules 301 is formed on the pixel electrode 110. In the present implementation example, the alignment film 113 has a two-layer structure including a photo-alignment component 1131 in contact with the liquid crystal layer 300 and a low resistance component 1132 formed in a layer below the photo-alignment component 1131 (on the side of the TFT substrate). The photo-alignment component 1131 is formed of polyamide acid ester and the low resistance component 1132 formed of polyamide acid.

In FIG. 1, a counter substrate 200 is provided so as to sandwich the liquid crystal layer 300. Color filters 201 are formed inside the counter substrate 200. Regarding the color filters 201, color filters 201 of red, green, and blue are formed for each pixel, so that a color image is formed. A black matrix 202 is formed between the color filters 201, so that the contrast of the image is improved. The black matrix 202 has a function of a light shielding film of the TFT and prevents a photoelectric current from flowing in the TFT.

An overcoat film 203 is formed to cover the color filters 201 and the black matrixes 202. The surfaces of the color filters 201 and the black matrixes 202 are uneven, so that the surfaces are flattened by the overcoat film 203.

An alignment film 114 for determining an initial alignment of the liquid crystal is formed on the overcoat film 203. The alignment film 114 on the counter substrate side is different from the alignment film 113 on the TFT substrate side and has a two-layer structure including a photo-alignment component 1131 in contact with the liquid crystal layer 300 and a high resistance component 1142 formed in a layer below the photo-alignment component 1131 (on the side of the counter substrate). The liquid crystal display device 1 is an IPS type liquid crystal display device, so that the counter electrode 108 is formed on the side of the TFT substrate 100 and is not formed on the side of the counter substrate 200.

As shown in FIG. 1, in the IPS type, no conductive film is formed inside the counter substrate 200. Therefore, the potential of the counter substrate 200 is unstable. Further, electromagnetic noise from the outside enters the liquid crystal layer 300 and affects the image. To eliminate such a problem, a surface conductive film 210 is formed outside the counter substrate 200.

A photo-alignment film material obtained by blending polyamide acid ester and polyamide acid into a varnish is printed on the TFT substrate 100, divided into an upper layer and a lower layer, irradiated with light, and heated into imide, so that the alignment film 113 is formed. The polyamide acid has a polarity higher than that of the polyamide acid ester and easily fits in ITO (Indium Tin Oxide) and an organic passivation film, so that the polyamide acid 1132 becomes the lower layer and the polyamide acid ester 1131 becomes the upper layer at all times. Here, the polyamide acid ester 1131 is the alignment component and the polyamide acid 1132 is the low resistance component.

A photo-alignment film material obtained by blending polyamide acid ester and polyamide acid into a varnish is printed on the counter substrate 200, divided into an upper layer and a lower layer, irradiated with light, and heated into imide, so that the alignment film 114 is formed. The lower layer is the polyamide acid 1142 and the upper layer is the polyamide acid ester 1131. Here, the polyamide acid ester 1131 is the alignment component and the polyamide acid 1142 is the high resistance component. The high resistance component 1142 whose transmittance is high is formed below the alignment film 114 on the side of the counter substrate, so that the transmittance is higher than that of the alignment film 113 on the side of the TFT substrate by 1.5% to 3%.

Although the two-layer alignment film including the photo-alignment component and the high resistance component is disclosed as the alignment film on the side of the counter substrate, a one-layer alignment film including only the high resistance component can also be used. In this case, the high resistance and the low resistance are based on the low resistance component of the alignment film on the side of the TFT substrate. When the one-layer alignment film including only the high resistance component is used as the alignment film of the counter substrate, the polyamide acid ester which is the photo-alignment component of the TFT substrate and the counter substrate may be used or the polyamide acid which is formed of a high resistance component having a photo-alignment function may be used. Further, to more improve the transmittance, the thickness of the alignment film on the side of the counter substrate may be smaller than the thickness of the alignment film on the side of the TFT substrate. The alignment film on the side of the TFT substrate may have a one-layer structure of a low resistance alignment film.

Although the alignment film on the side of the TFT substrate and the alignment film on the side of the counter substrate are a photo-alignment film including a photo-alignment component, these alignment films may be an alignment film whose photo-alignment component is a rubbing alignment component. For example, an alignment film including a photo-alignment component and a low resistance component may be used for the TFT substrate and a two-layer alignment film including a rubbing alignment component and a high resistance component may be used for the counter substrate. Even in this case, the rubbing alignment component is desired to have a resistance higher than that of a low resistance component the TFT substrate. A one-layer rubbing alignment film including a high resistance component may be used. Polyamide acid can be used as the rubbing alignment component and the high resistance component. The TFT substrate has a photo-alignment component, so that even when the TFT substrate has large surface unevenness, it is possible to sufficiently align even a portion shaded by the unevenness. At this time, it is desirable that a rubbing alignment film is applied to the entire surface of the counter substrate and a photo-alignment film is applied to the TFT substrate so as not to overlap a sealing material. The rubbing alignment film is well adhesive to the sealing material.

It takes a long tact time to switch an alignment film in a printing process, so that, according to a formation area of the alignment film, the alignment film on the side of the TFT substrate may be applied by flexographic printing and the alignment film on the side of the counter substrate may be applied by ink jet or spin coating, and conversely, the alignment film on the side of the TFT substrate may be applied by ink jet and the alignment film on the side of the counter substrate may be applied by printing.

While the invention made by the inventor has been specifically described based on the embodiment and the implementation example, it goes without saying that the present invention is not limited to the embodiment and the implementation example described above, but can be modified in various ways.

What is claimed is:

1. A liquid crystal display device comprising:
a TFT substrate;
a counter substrate;
a liquid crystal layer;
a first alignment film arranged between the TFT substrate and the liquid crystal layer; and
a second alignment film arranged between the counter substrate and the liquid crystal layer,
wherein the first alignment film includes a photo-alignment component and a low resistance component whose resistance is lower than that of the photo-alignment component, and
a transmittance of the second alignment film is greater than that of the first alignment film.

2. The liquid crystal display device according to claim 1, wherein
the photo-alignment component of the first alignment film is polyamide acid ester and the low resistance component of the first alignment film is polyamide acid.

3. The liquid crystal display device according to claim 2, wherein
the second alignment film includes a component whose resistance is higher than that of the low resistance component of the first alignment film.

4. The liquid crystal display device according to claim 3, wherein
the high resistance component of the second alignment film is a photo-aligned film.

5. The liquid crystal display device according to claim 4, wherein
the high resistance component of the second alignment film is polyamide acid ester.

6. The liquid crystal display device according to claim 3, wherein
the second alignment film is an alignment film on which a rubbing process is performed.

7. The liquid crystal display device according to claim 3, wherein
the first alignment film is an alignment film applied by a flexographic printing method and the second alignment film is an alignment film applied by ink jet.

8. The liquid crystal display device according to claim 3, wherein
the first alignment film is a film applied by ink jet and the second alignment film is an alignment film applied by a flexographic printing method.

9. The liquid crystal display device according to claim 3, wherein
the second alignment film is an alignment film including two layers.

10. The liquid crystal display device according to claim 1, wherein
the photo-alignment component and the low resistance component are separated from each other into two layers.
